(19) United States
(12) Patent Application Publication
(10) Pub. No.: US 2026/0214103 A1
(43) Pub. Date: Jul. 23, 2026

(54) Real-Time Monitoring of Safety Posture

(71) Applicant: Oracle International Corporation, Redwood Shores, CA (US)

(72) Inventors: Atul Goyal, Tracy, CA (US); Ashok Kumar S, Tiruppur (IN); Parthipan Kandasamy, Tiruppur (IN); Josson Joe Thoppil, Bengaluru (IN)

(21) Appl. No.: 19/032,784

(22) Filed: Jan. 21, 2025

(51) Int. Cl. H04L 9/40

(52) U.S. Cl. CPC H04L 63/1416; H04L 63/20

(57) ABSTRACT

In one embodiment, a software is operable when executed to receive a first user request from a first user to implement a change in a security policy, detect a dilution in security posture based on the implemented change in the security policy, request a first acknowledgement from the first user that the implemented change constitutes the dilution in the security posture responsive to detecting the dilution in the security posture, record the first acknowledgement from the first user that the implemented change constitutes the dilution in the security posture in a database, and determine whether a security breach occurred within a time period when the dilution in the security posture existed using the database.

### TECHNICAL FIELD

This disclosure generally relates to network security, and more specifically to monitoring security posture in a cloud computing environment.

### BACKGROUND

In the cloud computing environment, security is an integral part of any system to protect applications or resources. Malicious actors are finding various ways to take the ownership of accounts when security strength is minimal or not up-to-mark to handle modern security attacks. To guard highly sensitive applications in the cloud computing environment, a cloud infrastructure can provide elevated security posture, so that it can fight against the modern security attacks.

A cloud infrastructure can roll out security policies that will protect sensitive applications. An example security policy includes multi-factor authentication (MFA), and the security policy enforces the phishing-resistant factors as MFA factors. This makes it impossible for the malicious actor to take ownership of the account.

### BRIEF DESCRIPTION OF THE DRAWINGS

FIG. 1 illustrates an architecture of a security system, according to at least one embodiment.

FIG. 2 illustrates a flow diagram for policy change, according to at least one embodiment.

FIG. 3A illustrates a console showing an alert responsive to policy change, according to at least one embodiment.

FIG. 3B illustrates the console showing the security policy is changed, according to at least one embodiment.

FIG. 3C illustrates a real-time alert for the change of the security policy, according to at least one embodiment.

FIG. 4 illustrates a flow diagram for determining a security posture score for a security policy, according to at least one embodiment.

FIG. 5 illustrates a flow diagram for monitoring limits of cloud computing resources, according to at least one embodiment.

FIG. 6 illustrates a flow diagram for policy restoration, according to at least one embodiment.

FIG. 7A illustrates a console showing an alert responsive to policy restoration, according to at least one embodiment.

FIG. 7B illustrates a console showing the security policy is changed, according to at least one embodiment.

FIG. 7C illustrates a real-time alert for the restoration of the security policy, according to at least one embodiment.

FIGS. 8A-8B illustrate a method for monitoring dilution in security posture, according to at least one embodiment.

FIG. 9 is a block diagram illustrating an example pattern of an infrastructure-as-a-service (IaaS) architecture, according to at least one embodiment.

FIG. 10 is a block diagram illustrating another example pattern of an IaaS architecture, according to at least one embodiment.

FIG. 11 is a block diagram illustrating another example pattern of an IaaS architecture, according to at least one embodiment.

FIG. 12 is a block diagram illustrating another example pattern of an IaaS architecture, according to at least one embodiment.

FIG. 13 illustrates an example computer system, in which various embodiments may be implemented.

### DESCRIPTION OF EXAMPLE EMBODIMENTS

### Overview

According to an embodiment, one or more computer-readable non-transitory storage media may embody software executable for the following operations. The operations may include receiving a first user request from a first user to implement a change in a security policy. The operations may also include detecting a dilution in security posture based on the implemented change in the security policy. The operations may additionally include, responsive to detecting the dilution in the security posture, requesting a first acknowledgement from the first user that the implemented change constitutes a dilution in the security posture. The operations may then include recording, in a database, the first acknowledgement from the first user that the implemented change constitutes a dilution in the security posture. The operations may further include determining, using the database, whether a security breach occurred within a time period when the dilution in the security posture existed.

In certain embodiments, the first user may be a first domain administrator of a domain within a tenancy managed by a cloud service provider. Accordingly, the operations may additionally include, responsive to detecting the dilution in the security posture, sending notifications indicating the dilution in the security posture to a set of one or more users comprising a second domain administrator of the domain, a tenancy administrator of the tenancy, a security operator associated with the cloud service provider, or a security operator associated with the domain.

In certain embodiments, the first user may be associated with a tenancy managed by a cloud service provider. Accordingly, the operations may also include determining a tenancy type associated with the tenancy. The operations may additionally include determining a monitoring level for monitoring the tenancy based on the tenancy type and the dilution in the security posture. The operations may further include monitoring the tenancy at the determined monitoring level.

In certain embodiments, the operations may further include receiving a second user request from a second user to restore the security policy to a default setting. The first user and the second user may be a same user or different users. The operations may also include requesting a second acknowledgement from the second user that the restoration constitutes reverting back the implemented change in the security posture. The operations may further include recording, in the database, the second acknowledgement from the second user that the restoration constitutes reverting back the implemented change in the security posture. The operations may additionally include sending notifications indicating the restoration of the security posture to the set of users.

In certain embodiments, requesting the first acknowledgement from the first user that the implemented change constitutes the dilution in the security posture may be responsive to determining the first acknowledgement that the implemented change constitutes the dilution in the security posture does not exist in the database.

In certain embodiments, the operations may further include determining a risk score corresponding to the dilution in the security posture based on the implemented change in the security policy. The risk score may be determined based on the security policy. In an embodiment, the first user may be associated with a tenancy managed by a cloud service provider. Accordingly, the operations may also include determining a monitoring level for monitoring the tenancy based on the risk score and monitoring the tenancy at the determined monitoring level.

In certain embodiments, the first user may be associated with a domain. The operations may further include receiving a credit request associated with a security breach in the domain. The operations may then include rejecting the credit request responsive to determining that the security breach occurred within the time period when the dilution in the security posture existed.

In certain embodiments, the first user may be associated with a domain. The first user or a second user associated with the domain cannot modify or delete the recorded first acknowledgement in the database.

In certain embodiments, the security policy may be configured for accessing resources provisioned by a cloud service provider.

In certain embodiments, the operations may further include, in response to receiving the first user request, implementing the change in the security policy.

According to another embodiment, one or more computer-readable non-transitory storage media may embody software executable for the following operations. The operations may include receiving a first user request from a first user to implement a change in a security policy. The operations may also include detecting a dilution in security posture based on the implemented change in the security policy. The operations may further include, responsive to detecting the dilution in the security posture, increasing a monitoring level for monitoring a tenancy associated with the first user.

In certain embodiments, the first user may be associated with a domain managed by a cloud service provider. Increasing the monitoring level may comprise disabling an ability of the first user or a second user associated with the domain to change a limit of resources that the second user is eligible for consuming. In an embodiment, the resources may be provisioned by the cloud service provider.

In certain embodiments, the first user may be associated with a domain managed by a cloud service provider. Increasing the monitoring level may comprise prohibiting a change in consumption of resources by the first user or a second user associated with the domain from exceeding a threshold value. In an embodiment, the resources may be provisioned by the cloud service provider.

In certain embodiments, the first user may be associated with a domain managed by a cloud service provider. Increasing the monitoring level may comprise generating an alert upon determining consumption of resources by the first user or a second user associated with the domain exceeds a threshold value. In an embodiment, the resources may be provisioned by the cloud service provider.

In certain embodiments, the operations may further include receiving a second user request from a second user to restore the security policy to a default setting. The operations may then include decreasing the monitoring level for monitoring the tenancy.

According to another embodiment, a system may include one or more processors and a non-transitory memory coupled to the processors comprising instructions, when executed by the one or more processors, cause the one or more processors to execute the following operations. The operations may include receiving a first user request from a first user to implement a change in a security policy. The operations may also include detecting a dilution in security posture based on the implemented change in the security policy. The operations may additionally include, responsive to detecting the dilution in the security posture, requesting a first acknowledgement from the first user that the implemented change constitutes a dilution in the security posture. The operations may then include recording, in a database, the first acknowledgement from the first user that the implemented change constitutes a dilution in the security posture. The operations may further include determining, using the database, whether a security breach occurred within a time period when the dilution in the security posture existed.

Technical advantages of certain embodiments of this disclosure may include one or more of the following. The disclosed systems and methods can improve security as different types of users are warned when a dilution in security posture is detected responsive to an attempted change of a security policy. The disclosed system and method can also effectively handle security attacks by increasing the monitoring level upon detecting a dilution in security posture. For example, increasing the monitoring level may include disabling a user's ability to change a limit of resources that the user is eligible for consuming, prohibiting changes in resource consumption from exceeding a threshold value, and generating an alert upon determining resource consumption by the user exceeds a threshold value.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

The embodiments disclosed herein relate to a security system that protects sensitive applications in the cloud computing environment. The security system may help users and cloud infrastructure monitor and keep track of security posture dilution. For various reasons security policy may be weakened by users. Whenever a change occurs, real-time alerts may be issued to respective security administrators of the user, and a cloud infrastructure may report security posture weakness in a console. The security system may maintain a ledger to keep track of changes to perform retrospective of changes to the security policy. At any point of time, a user can roll back to the elevated security posture provisioned by the cloud infrastructure. Although this disclosure describes monitoring particular posture dilutions by particular systems in particular manners, this disclosure contemplates monitoring any suitable posture dilution for any suitable system in any suitable manner.

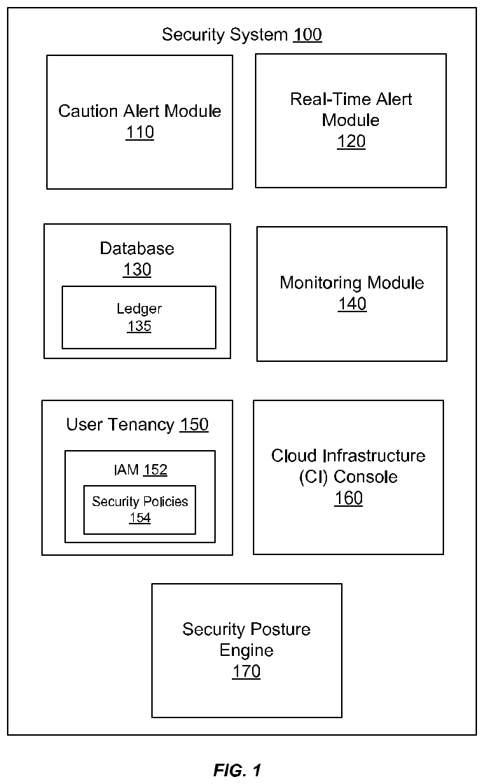

FIG. 1 illustrates an architecture of a security system 100, according to at least one embodiment. The security system 100 may be associated with a cloud infrastructure. The security system 100 may include a caution alert module 110, a real-time alert module 120, a database 130, a monitoring module 140, a user tenancy 150, a cloud infrastructure (CI) console 160, and a security posture engine 170.

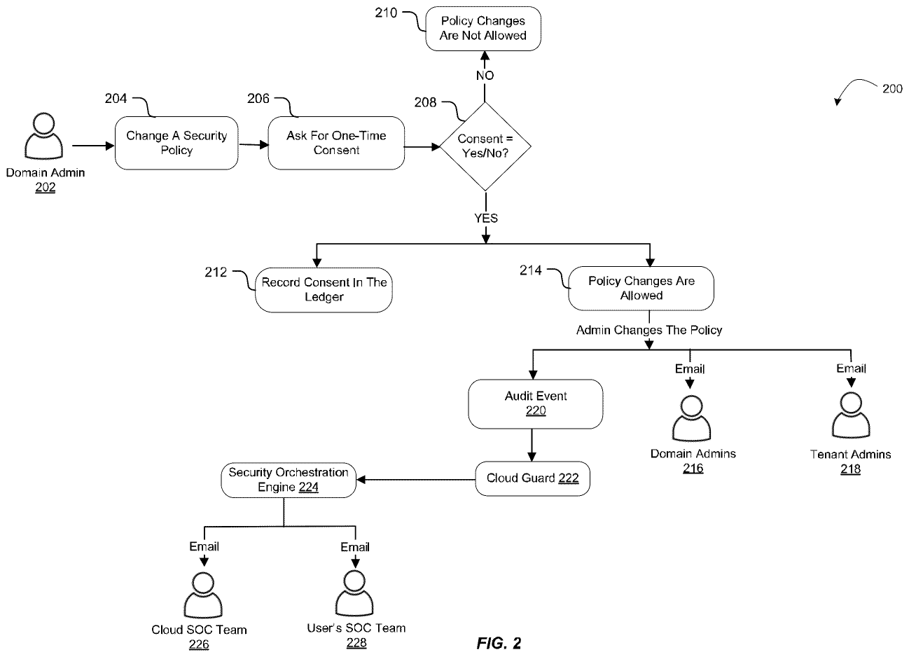

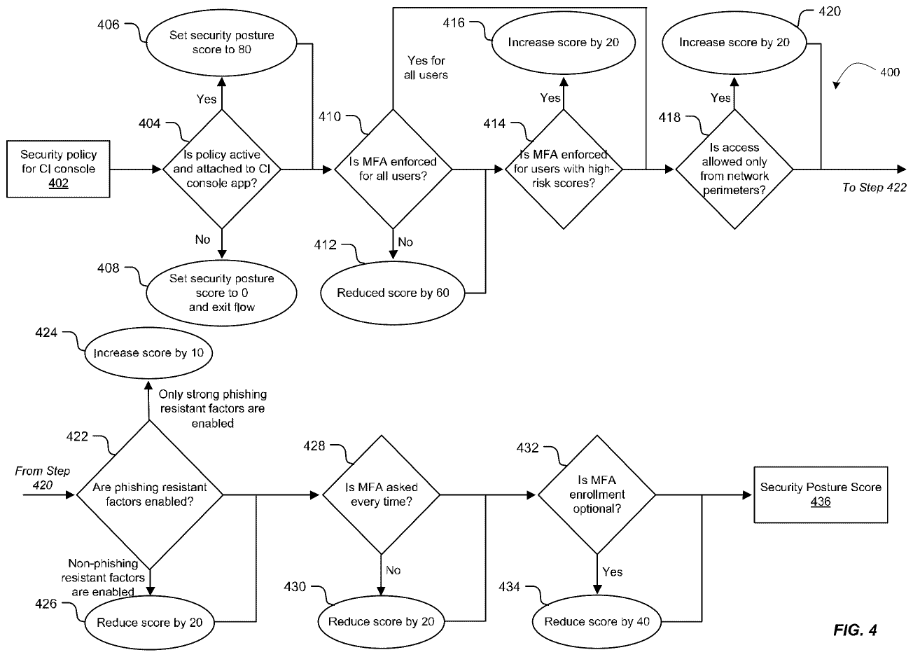

The user tenancy 150 may include identity and access management (IAM) 152. IAM 152 may control who has access to the cloud resources and what type of access users have and to which specific resources. IAM 152 may include security policies 154. A security policy 154 may include a document that specifies who can access which resources, and how. Access may be granted at the group and compartment level, which means a security policy may give a group of users a specific type of access to the tenancy itself. A user can make changes to security policies and restore changed security policies. Examples of operations for changing and restoring security policies are described herein with reference to FIG. 2 and FIG. 4.

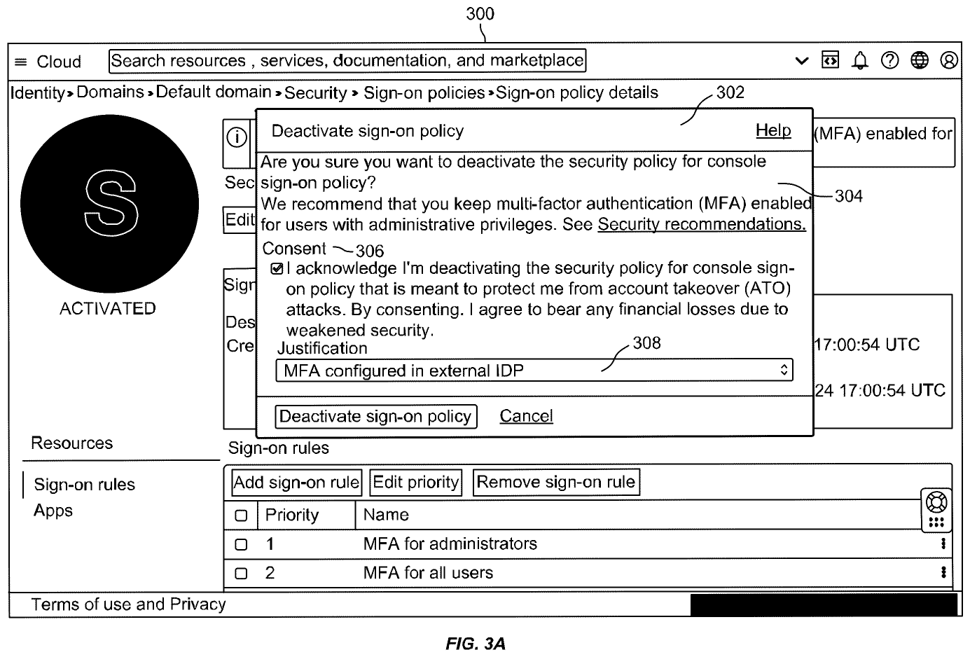

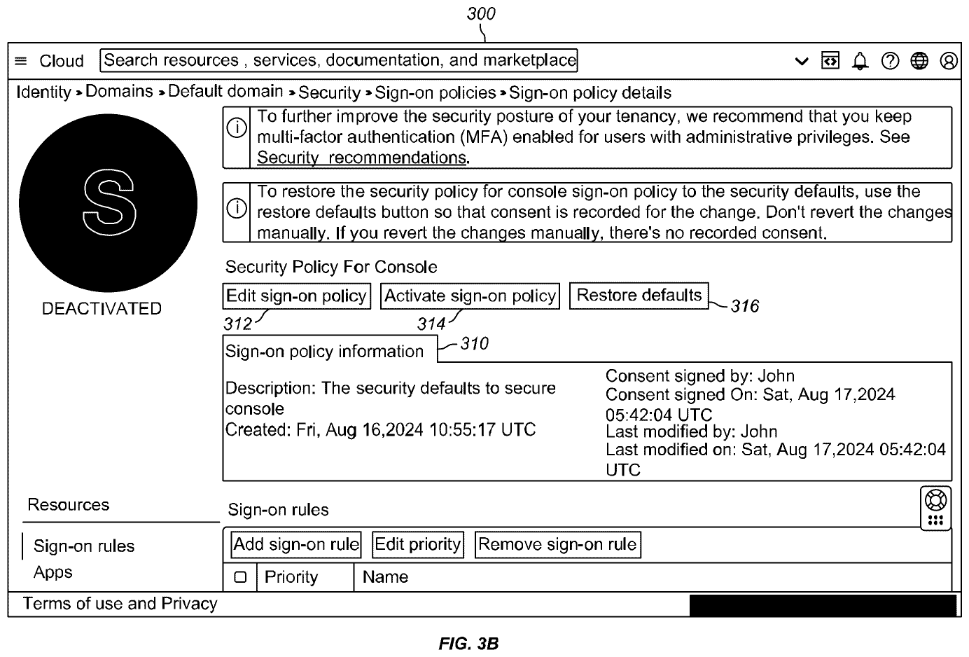

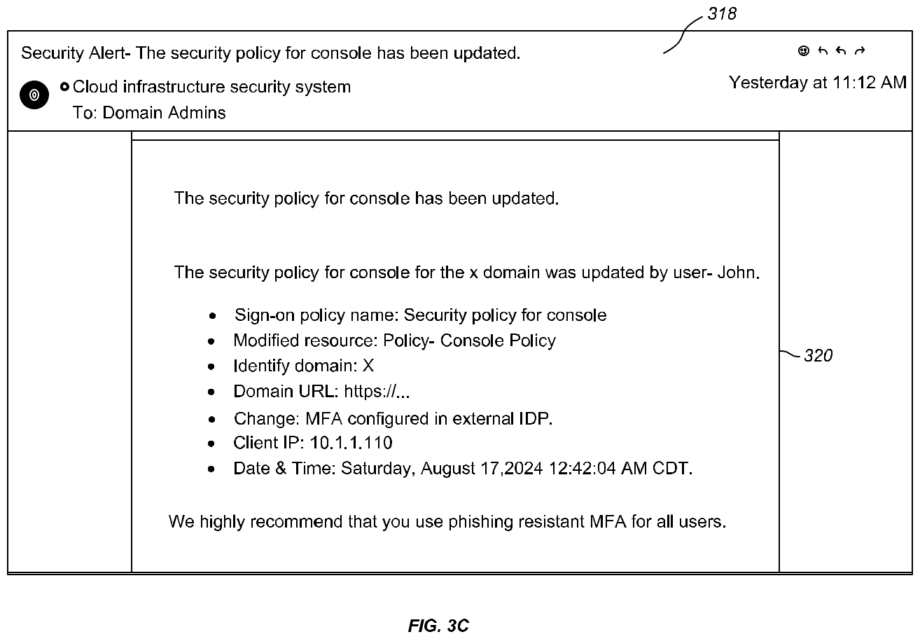

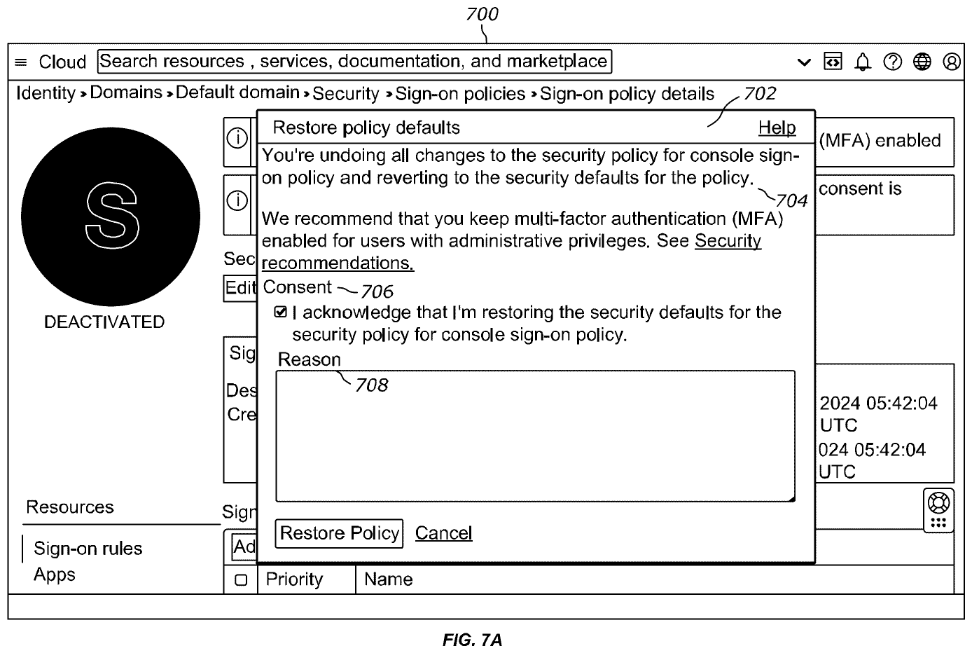

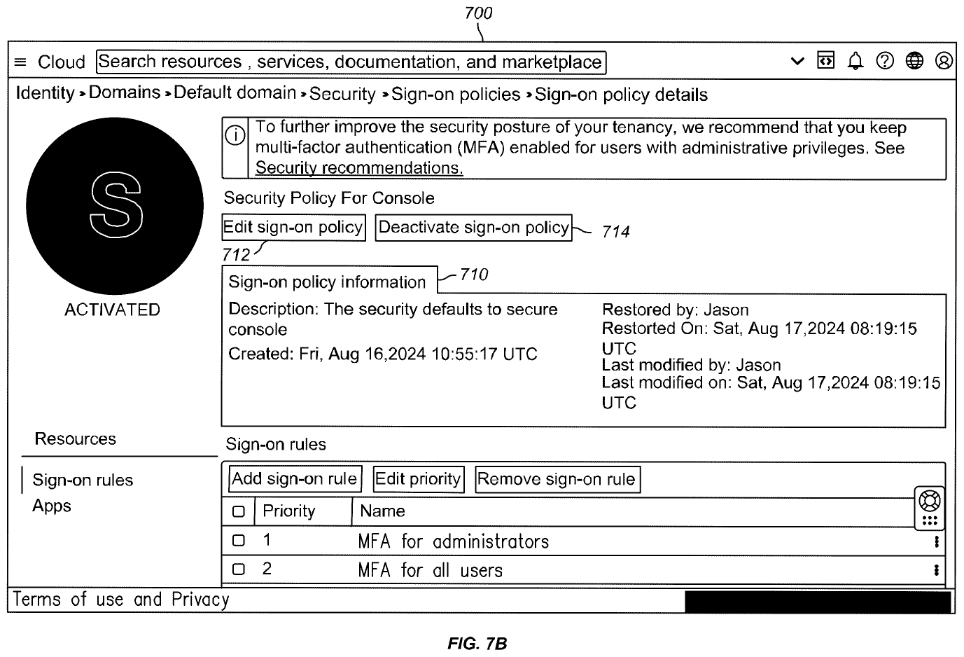

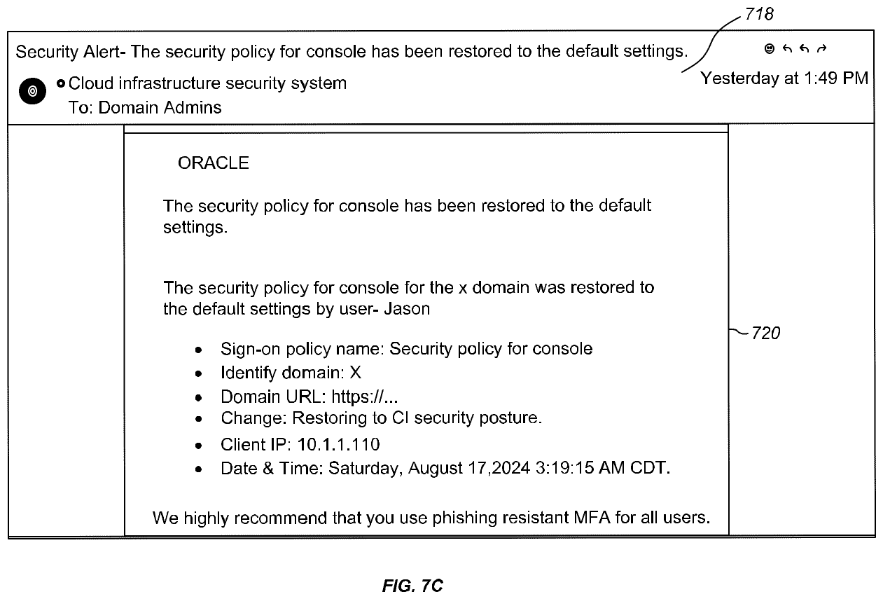

The CI console 160 can be a web-based interface for managing the services provided by the cloud infrastructure, which centralizes control of cloud resources, services, and applications. The CI console 160 can help users with monitoring, security, and operational efficiency. A user can make a change or a restoration to a security policy via the CI console 160. Examples of operations for changing and restoring security policies are described herein with reference to FIG. 3A, FIG. 3B, FIG. 7A, and FIG. 7B.

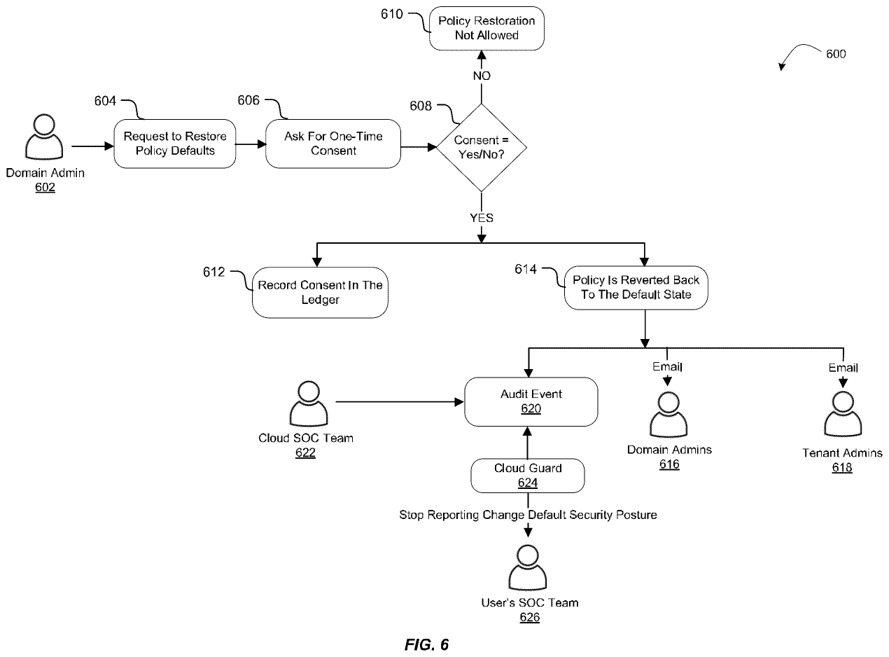

When the security system 100 detects a change to a security policy would constitute a dilution of security posture, the caution alert module 110 may generate a caution alert. In an example embodiment, the caution alert may be displayed at the CI console 160 before the user submits the change to the security system 100. When a user attempts to restore a security policy, the caution alert module 110 may also generate a caution alert. The caution alert may request the user's consent before the change or restoration to the security policy. Examples of operations for generating caution alert are described herein with reference to FIG. 2, FIG. 3A, FIG. 6, and FIG. 7A.

In particular embodiments, a user may need to provide certain details, e.g., reasons, along with the consent. For example, the user may provide the consent and details in a pop-up window of the caution alert in the CI console 160. The consent and details provided in the caution alert may be stored in the ledger 135 of the database 130. The security system 100 may use the ledger 135 to track changes to security policies. Examples of operations for providing consent and details are described herein with reference to FIG. 2, FIG. 3A, FIG. 6, and FIG. 7A.

As soon as the consent and details are recorded, the real-time alert module 120 may send out real-time alerts (e.g., emails) regarding the change or restoration to the security policy to administrators of the domain, administrators of the tenancy, security operation team associated with the cloud infrastructure, or security operation team associated with the domain, etc. Examples of operations for real-time alerts are described herein with reference to FIG. 2, FIG. 3C, FIG. 6, and FIG. 7C.

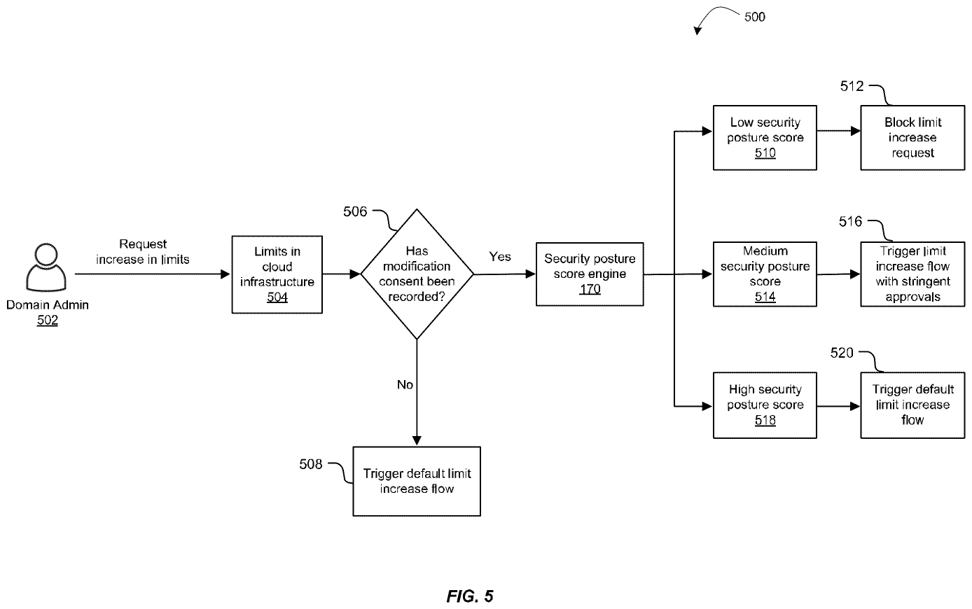

In particular embodiments, the monitoring module 140 may determine a tenancy type associated with the tenancy of the user, determine a monitoring level for monitoring the tenancy based on the tenancy type and the dilution in the security posture, and monitoring the tenancy at the determined monitoring level. The monitoring module 140 may further adjust a monitoring level. For example, the monitoring module may disable the user's ability to change the limit of resources that the user is eligible for consuming, prohibiting changes in resource consumption from exceeding a threshold value, and generating an alert upon determining resource consumption by the user exceeds a threshold value. Examples of operations for tenancy monitoring are described herein with reference to FIG. 5.

In particular embodiments, the security posture engine 170 may determine a security posture score for a security policy to be changed. The security posture score can be used by the monitoring module 140 to determine the monitoring level for monitoring the tenancy. Examples of operations for determining security posture scores are described herein with reference to FIG. 4.

FIG. 2 illustrates a flow diagram 200 for policy change, according to at least one embodiment. At step 204, a domain admin 202 may change a security policy. For example, the domain admin 202 may change the default MFA policy of a console used for accessing the cloud infrastructure. Upon detecting that the domain administrator 202 attempts to make change to a security policy, the security system (e.g., security system 100 of FIG. 1) may determine if the attempted change would lead to a dilution in security posture. For example, removal of MFA, reducing password complexity requirements, disabling account lockout after failed login attempts, extending single sign-on session duration, reducing session timeout for inactivity, and/or removing IP whitelisting for remote access may be considered a dilution in security posture.

At step 206, the security system may ask for one-time consent using an alert upon detecting a dilution in security posture. In the alert, a warning message is displayed. For example, the message may be “you are changing the default security posture which will protect you from account takeover (ATO) attacks. By consenting here you agree to bear all financial losses due to weak security posture.” In addition, the administrator may provide certain details to be stored along with the changes to the security policy. This alert can prevent accidental misconfigurations, as domain administrators provide details. The warning message can help the administrators to understand the changes to the security policy.

At step 208, the security system may determine whether the domain admin 202 consents. If the domain admin 202 does not consent, the security system may determine policy changes are not allowed at step 210.

If the domain admin 202 consents, the security system may record the consent in the ledger at step 212. The consent database may be modeled as a ledger. For example, the recorded consent may include user information, date, location, policy state (changed), etc. In certain embodiments, once written to the database, the consent cannot be modified or deleted by the domain admin 202 or any other admins from that domain. Users in that domain can view the consent to keep track of changes. The cloud infrastructure can internally record the consent, but the recorded consent cannot be modified or deleted. This property makes the consent database trustworthy for the cloud infrastructure and users of the cloud infrastructure to perform retrospective analysis after any account takeover happens.

At step 214, the security system 100 may determine policy changes are allowed if the domain admin 202 consents. As a result, the domain admin 202 changes the policy.

In particular embodiments, the security system may also send out real-time alerts, e.g., emails to domain admins 216 and tenant admins 218. For example, the email may read: “Email—Security Alert User John has consented and changed the default security policy in the domain—X. You will be responsible for all financial losses due to weak security posture.” The real-time alerts can provide users of the cloud infrastructure the option to roll back to the recommended security posture quickly whenever the security policy is modified due to lack of security knowledge or rogue administrators, etc.

The security system may create an audit event 220 and send the event to a security data warehouse (e.g., a cloud guard 222). In particular embodiments, the cloud guard 222 is a service included provided by the user's tenancy in the cloud infrastructure to improve security posture. The cloud guard 222 can detect threats, pinpoint misconfigurations, monitor insecure activity across tenancies, and empower security administrators with outstanding visibility to help swiftly resolve cloud security issues.

If weak posture is identified by analyzing the consent data, the cloud guard 222 may create and send an event into a security orchestration engine 224. The security orchestration engine 224 may create tickets in queues for the security operation center (SOC) 226 of the cloud infrastructure and in queues for the SOC 228 of the users of the cloud infrastructure.

FIG. 3A illustrates a console 300 showing an alert responsive to policy change, according to at least one embodiment. A user may attempt to deactivate the sign-on policy. The security system 100 may detect a dilution in security posture and display an alert 302. The alert 302 may show the potential security risk 304. The alert 302 may also request the user's consent 306. The alert 302 may additionally require the user to input certain details, e.g., justification 308 for the change of security policy.

FIG. 3B illustrates the console 300 showing the security policy is changed, according to at least one embodiment. The console 300 may show detailed information 310 of the change to the security policy. The console 300 may additionally show options related to the changed security policy, such as “edit sign-on policy 312,” “activate sign-on policy 314,” and “restore defaults 316.”

FIG. 3C illustrates a real-time alert for the change of the security policy, according to at least one embodiment. The real-time alert may be an email 318 sent from the cloud infrastructure security system to the domain admins. The email 318 may include detailed information 320 of the change to the security policy.

Based on various factors, the security system (e.g., the security system of FIG. 1) may assign a security posture score to a security policy to be changed. The security posture score is also referred as a risk score in this disclosure. For example, a default security posture score may be 80, a strong security posture score may be 70-100, a medium security posture score may be 40-70, and a weak security posture may be 0-40. The security system may further determine the monitoring level of resource consumption for an associated tenancy.

Table 1 shows an analysis of different configurations of the security policy for the console and what may be considered a diluted or stronger security posture.

TABLE 1
Configurations of the security policy.

| | Default Security | Diluted | Stronger |
|---|---|---|---|
| Configuration | Posture | Posture | Posture |
| Group | All Users | Only a few | Cannot go above |
| Membership | | groups | default posture |
| Risk | None - Does | Cannot go below | Force MFA for |
| Conditions | not consider | default posture | high-risk users |
| | the user's | | |
| | risk score | | |
| Network | Anywhere - | Cannot go below | Restrict access |
| Perimeters | No network | default posture | to the network |
| | restrictions | | perimeters |
| MFA | ON | OFF | Cannot go above |
| | | | default posture |
| MFA Factors | Phishing | Non-phishing | Only strong |
| Activated | resistant | resistant factors | phishing |
| | factors | enabled | resistant factors |
| | | | are enabled |
| MFA | Every time | Once per session | Cannot go above |
| Frequency | | or trusted device | default posture |
| MFA | Mandatory | Optional | Cannot go above |
| Enrollment | | | default posture |

FIG. 4 illustrates a flow diagram 400 for determining a security posture score for a security policy, according to at least one embodiment. For a security policy 402 for CI console, the security system 100 may determine whether the policy is active and attached to CI console app at step 404. If the policy is active and attached to CI console app, at step 406, the security system 100 may set security posture score to 80, which corresponds to a seeded security posture. If the policy is not active and attached to CI console app, the security system 100 may set security posture score to 0 and exit the flow 400 at step 408.

The flow diagram 400 then proceeds to step 410, where the security system (e.g., security system 100 of FIG. 1) may determine whether MFA is enforced for all users. If MFA is enforced for all users, the flow diagram 400 proceeds to step 418. If MFA is not enforced for all users, the security system 100 may reduce the score by 60 at step 412. At step 414, the security system 100 may further determine whether MFA is enforced for users with high-risk scores. If MFA is enforced for users with high-risk scores, the security system 100 may increase the score by 20 at step 416.

At step 418, the security system may determine whether access is allowed (e.g., only allowed) from network perimeters. If access is allowed (e.g., only allowed) from network perimeters, the security system may increase the score by 20 at step 420. The flow diagram 400 then proceeds to step 422. At step 422, the security system 100 may determine whether phishing resistant factors are enabled. If only strong phishing resistant factors are enabled, the security system 100 may increase the score by 10 at step 424. If non-phishing resistant factors are enabled, the security system may reduce the score by 20 at step 426.

At step 428, the security system may determine whether MFA is asked every time. By default, MFA may be asked every time. If MFA is not asked every time, e.g., only once per session or not asked on a trusted device, the security system may reduce the score by 20 at step 430.

At step 432, the security system may determine whether MFA enrollment is optional. By default, MFA enrollment may not be optional. If MFA enrollment is optional, the security system may reduce the score by 40 at step 434.

The flow diagram 400 may end with the final security posture score 436. The security posture score may have a value between 0 and 100.

Although FIG. 4 describes and illustrates particular steps of determining a security posture score for a security policy as occurring in a particular order, such steps and order are merely examples and this disclosure contemplates any suitable approach of determining a security posture score for a security policy.

FIG. 5 illustrates a flow diagram 500 for monitoring limit of cloud computing resources, according to at least one embodiment. A domain admin 502 may request increase in limits regarding the limits of resource consumption in the cloud infrastructure 504.

At step 506, the security system (e.g., security system 100 of FIG. 1) may determine whether modification consent of a default security policy has been recorded. If the default security policy has never been modified, the security system may trigger a default limit increase flow at step 508, e.g., increasing the limit of resource consumption by the domain admin 502.

If the default security policy has been modified, the security system may access the security posture score engine 170 to obtain the security posture score of the MFA posture. If the security system obtains a low security posture score 510, e.g., 0-40, the security system may block the limit increase request at step 512. If the security system obtains a medium security posture score 514, e.g., 40-70, the security system may trigger limit increase flow with stringent approvals at step 516. If the security system obtains a high security posture score 518, e.g., 70-100, the security system 100 may trigger default limit increase flow at step 520.

Although FIG. 5 describes and illustrates particular steps of denying/approving particular requests with particular modifications based on security posture scores, such steps and requests are merely examples and this disclosure contemplates any suitable step of denying/approving any suitable request with any suitable modification based on security posture scores. For example, a request to instantiate a top-of-the-line compute instance can also get denied if the security posture score is too low.

FIG. 6 illustrates a flow diagram 600 for policy restoration, according to at least one embodiment.

At step 604, a domain admin 602 may request to restore policy defaults. For example, the domain admin 602 may request to change the MFA policy to its default settings.

At step 606, the security system (e.g., security system 100 of FIG. 1) may request one-time consent using an alert. In the alert, a warning message is displayed. For example, the message may be “You are reverting back your changes and applying the security default setting provided by the cloud infrastructure for console access of the cloud infrastructure.”

At step 608, the security system may determine whether the domain admin 602 consents. If the domain admin 602 does not consent, the security system may determine policy restoration is not allowed at step 610.

If the domain admin 602 consents, the security system may record the consent in the ledger at step 612. For example, the recorded consent may include user information, date, location, policy state (changed), etc.

At step 614, the security system may determine policy is reverted back to the default state if the domain admin 602 consents.

In particular embodiments, the security system may also send out real-time alerts, e.g., emails to domain admins 616 and tenant admins 618. For example, the email may read: “Email—Security Alert User John has restored security policy for the console for accessing the cloud infrastructure.”

The security system may create an audit event 620. The cloud SOC team 622 may determine to stop monitoring the tenancy associated with the domain admin 602.

The security data warehouse (e.g., the cloud guard 624) may analyze the audit event 620. Upon analysis, the cloud guard 624 may stop reporting changes to default security posture to the user's SOC team 626.

FIG. 7A illustrates a console 700 showing an alert responsive to policy restoration, according to at least one embodiment. A user may attempt to restore policy defaults for a policy. The security system (e.g., security system 100 of FIG. 1) may display an alert 702. The alert 702 may show the outcome 704 of the restoration. In certain embodiments, the alert 702 may request the user's consent 706. In some embodiments, the alert 702 may require the user to input certain details, e.g., reason 708 for the restoration of security policy.

FIG. 7B illustrates the console 700 showing the security policy is changed, according to at least one embodiment. The console 700 may show detailed information 710 of the restoration of the security policy. The console 700 may additionally show options related to the restored security policy, such as “edit sign-on policy 712” and “deactivate sign-on policy 714.”

FIG. 7C illustrates a real-time alert for the restoration of the security policy, according to at least one embodiment. The real-time alert may be an email 718 sent from the cloud infrastructure security system to the domain admins. The email 718 may include detailed information 720 of the restoration to the security policy.

According to the embodiments disclosed herein, an example timeline of security posture changes is described below. At Day 0, the cloud infrastructure rolls out elevated security posture called “Security Policy for Console.” At Day 1, a first domain administrator requests to modify sign-on policy “Security Policy for Console.” The security system (e.g., security system 100 of FIG. 1) then requests consent before saving sign-on policy. The domain administrator provides the consent and a reason before saving the policy change. The security system records the consent in the ledger (e.g., ledger 135 of FIG. 1). The security system then sends the real-time alert to all domain administrators. An alert of the change is also sent to the console.

At Day X, a second domain administrator modifies sign-on policy “Security Policy for Console”. This time no consent is asked by the security system because the consent is already recorded on Day 1. At Day X+5, an account takeover happens. At Day X+10, the cloud provider of the cloud infrastructure recovers the account after the user of the cloud infrastructure reports about the malicious activity.

At Day X+11, a third domain administrator assesses the sign-on policy “Security Policy for Console” and finds that the strength of security cannot guard against modern attacks. Therefore, the third domain administrator attempts to restore the sign-on policy to the security strength rolled out by the cloud infrastructure at Day 0. The security system then asks for consent before restoring the sign-on policy. The third domain administrator provides the consent and the reason before restoring the sign-on policy. The security system records the consent in the ledger. The security system then sends the real-time alert to all domain administrators. The security operation team then detects the restoration and sends an alert to the console.

At Day X+N, the user of the cloud infrastructure reaches the cloud provider for waive-off request. The cloud provider analyzes the ledger and finds that the account takeover happened due to a weakness in the security of sign-on policy. The cloud provider additionally finds that the account takeover happened after the policy was changed by a domain administrator of the user. The cloud provider then rejects the waive-off request because the account takeover happened due to policy changes made by the user.

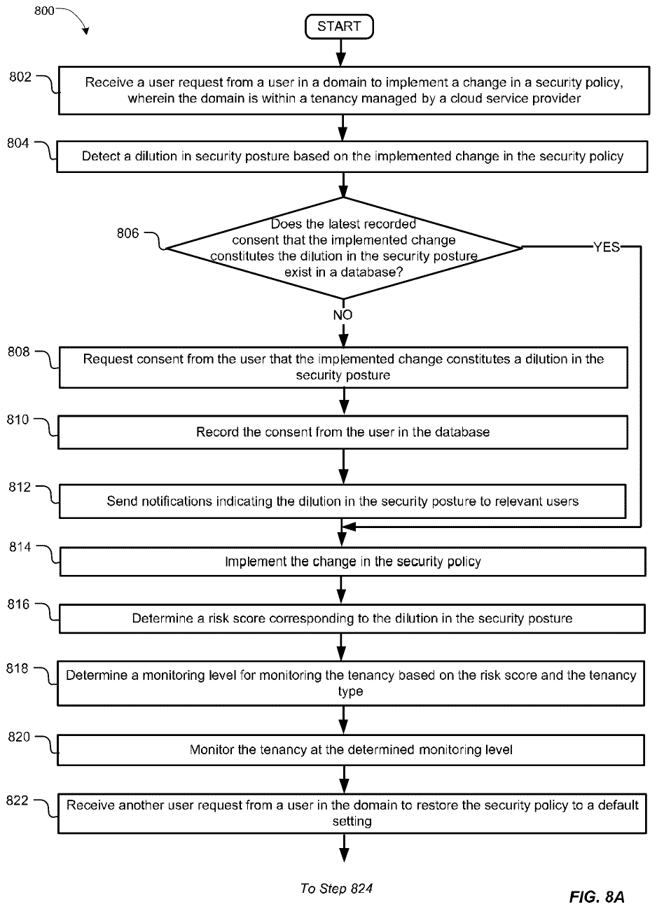

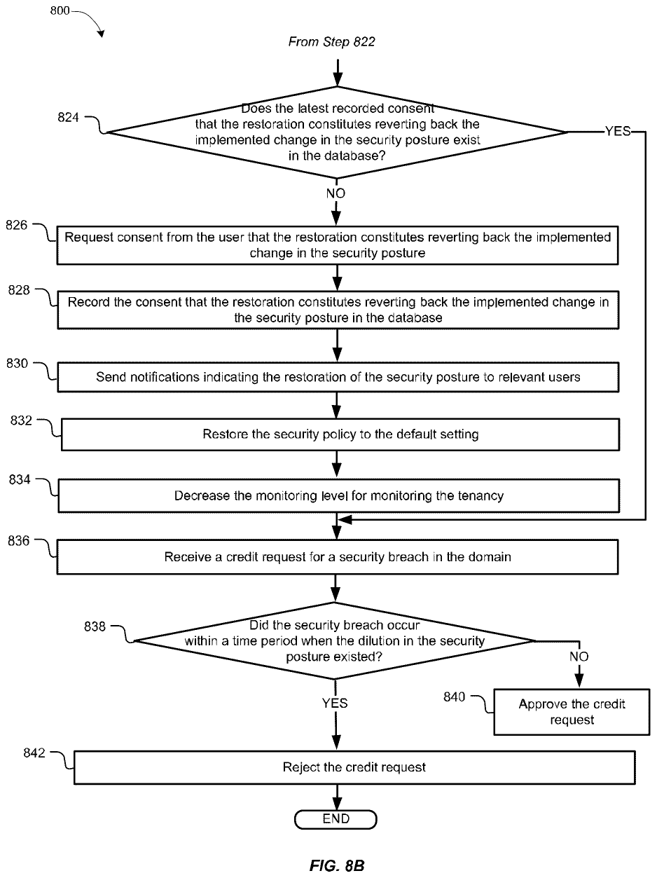

FIGS. 8A-8B illustrate a method 800 for monitoring dilution in security posture, according to at least one embodiment. The method 800 may begin at step 802, where the security system (e.g., security system 100 of FIG. 1) may receive a user request from a user in a domain to implement a change in a security policy. The user request may be received via a CI console. In an embodiment, the domain is within a tenancy managed by a cloud service provider.

At step 804, the security system may detect a dilution in security posture based on the implemented change in the security policy. The security policy may be configured for accessing resources provisioned by a cloud service provider.

At step 806, the security system may determine whether the latest recorded consent that the implemented change constitutes the dilution in the security posture exist in the database 130. If the latest recorded consent that the implemented change constitutes the dilution in the security posture exist in the database (e.g., database 130 of FIG. 1), method 800 proceeds to step 814, wherein the security system may implement the change in the security policy.

If the latest recorded consent that the implemented change constitutes the dilution in the security posture does not exist in the database, method 800 proceeds to step 808, wherein the security system may request consent from the user that the implemented change constitutes a dilution in the security posture. For example, a warning message may be displayed on the CI console, requesting the user to consent and provide justification for the change.

At step 810, the security system may record the consent from the user in the database. Once recorded, users from that domain cannot modify or delete the recorded consent from the database. The security system may send notifications indicating the dilution in the security posture to relevant users at step 812. For example, these users may include domain administrator(s), tenancy administrator(s), security operator(s), etc. The notifications can be sent via a plurality of channels such as email, SMS, messaging tools, etc.

At step 814, the security system may then implement the change in the security policy.

At step 816, the security system may determine a risk score corresponding to the dilution in the security posture. The risk score is also referred as security posture score in this disclosure. Example operations of determining risk score/security posture score can be referred to the flow diagram 400 in FIG. 4.

At step 818, the security system may determine a monitoring level for monitoring the tenancy based on the risk score and the tenancy type. In an embodiment, the monitoring level may be increased from a previous monitoring level.

At step 820, the security system may monitor the tenancy at the determined monitoring level. For example, monitoring the tenancy at an increased level may include disabling ability of the user or any other user from that domain to change a limit of resources that the domain users are eligible for consuming, prohibiting a change in consumption of resources by the user or any other user from that domain from exceeding a threshold value, or generating an alert upon determining consumption of resources by the user or any other user from that domain exceeds a threshold value.

At step 822, the security system may receive another user request from a user in the domain to restore the security policy to a default setting. The user request may be received via the CI console.

At step 824, the security system may determine whether the latest recorded consent that the restoration constitutes reverting back the implemented change in the security posture exist in the database. If the latest recorded consent that the restoration constitutes reverting back the implemented change in the security posture exist in the database, method 800 proceeds to step 836.

If the latest recorded consent that the restoration constitutes reverting back the implemented change in the security posture does not exist in the database, method 800 proceeds to step 826, wherein the security system may request consent from the user that the restoration constitutes reverting back the implemented change in the security posture. For example, a warning message may be displayed on the CI console, requesting the user to consent and provide justification for the restoration.

At step 828, the security system may record the consent that the restoration constitutes reverting back the implemented change in the security posture in the database.

At step 830, the security system may send notifications indicating the restoration of the security posture to relevant users. For example, these users may include domain administrator(s), tenancy administrator(s), security operator(s), etc. The notifications can be sent via a plurality of channels such as email, SMS, messaging tools, etc.

At step 832, the security system may restore the security policy to the default setting.

At step 834, the security system may decrease the monitoring level for monitoring the tenancy.

At step 836, the security system may receive a credit request for a security breach in the domain. For example, the credit request may be a user's request for the cloud service provider to write off charges.

At step 838, the security system may determine whether the security breach occurred within a time period when the dilution in the security posture existed by checking the database 130. If the security breach did not occur within the time period when the dilution in the security posture existed, the security system may approve the credit request at step 840.

If the security breach occurred within the time period when the dilution in the security posture existed, the security system may reject the credit request at step 842. For example, an attacker spun up many compute instances in a user's tenancy. The compute instances are charged to the user. The user requests the cloud to write off the charges, reasoning that the attacker should not have been able to get into the user's tenancy. The cloud service provider can look up its records, e.g., the ledger. The records may reveal that the user consented to the weakened security posture and consented to accepting the risk of financial losses due to the weakened security posture. The cloud service provider may therefore reject the request.

Method 800 then ends.

Particular embodiments may repeat one or more steps of the method of FIGS. 8A-8B, where appropriate. Although this disclosure describes and illustrates particular steps of the method of FIGS. 8A-8B as occurring in a particular order, this disclosure contemplates any suitable steps of the method of FIGS. 8A-8B occurring in any suitable order. Moreover, although this disclosure describes and illustrates an example method for monitoring dilution in security posture including the particular steps of the method of FIGS. 8A-8B, this disclosure contemplates any suitable method for monitoring dilution in security posture including any suitable steps, which may include all, some, or none of the steps of the method of FIGS. 8A-8B, where appropriate. Furthermore, although this disclosure describes and illustrates particular components, devices, or systems carrying out particular steps of the method of FIGS. 8A-8B, this disclosure contemplates any suitable combination of any suitable components, devices, or systems carrying out any suitable steps of the method of FIG. 8.

As described above, the embodiments disclosed herein can be utilized in infrastructure as a service (IaaS). Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

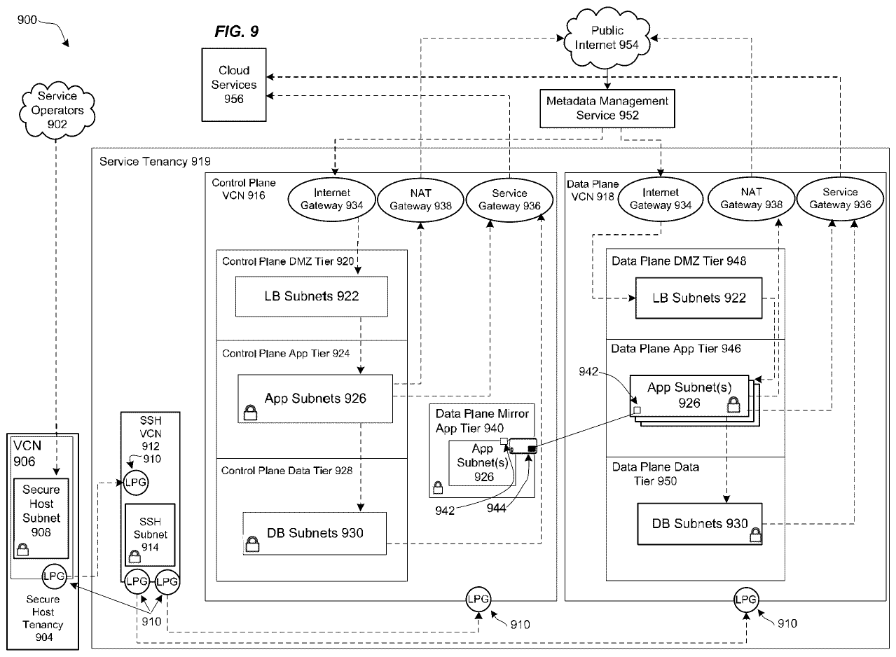

FIG. 9 is a block diagram 900 illustrating an example pattern of an infrastructure-as-a-service (IaaS) architecture, according to at least one embodiment. Service operators 902 can be communicatively coupled to a secure host tenancy 904 that can include a VCN 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively couple to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

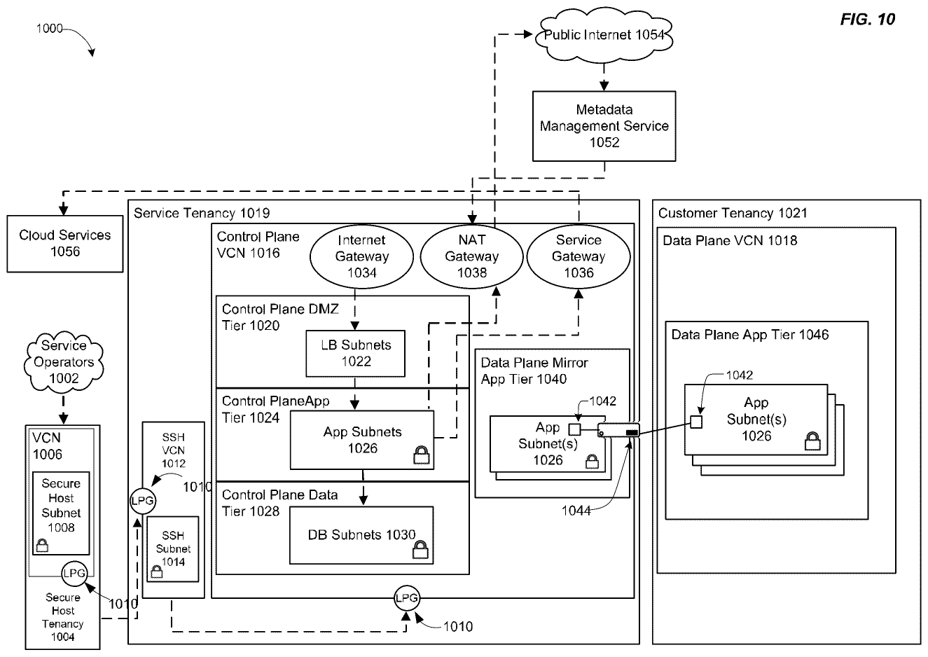

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a VCN 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively couple to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 6,” may be located in Region 1 and in “Region 2.” If a call to Deployment 6 is made by the service gateway 1036 contained in the control plane VCN 1016 located in Region 1, the call may be transmitted to Deployment 6 in Region 1. In this example, the control plane VCN 1016, or Deployment 6 in Region 1, may not be communicatively coupled to, or otherwise in communication with, Deployment 6 in Region 2.

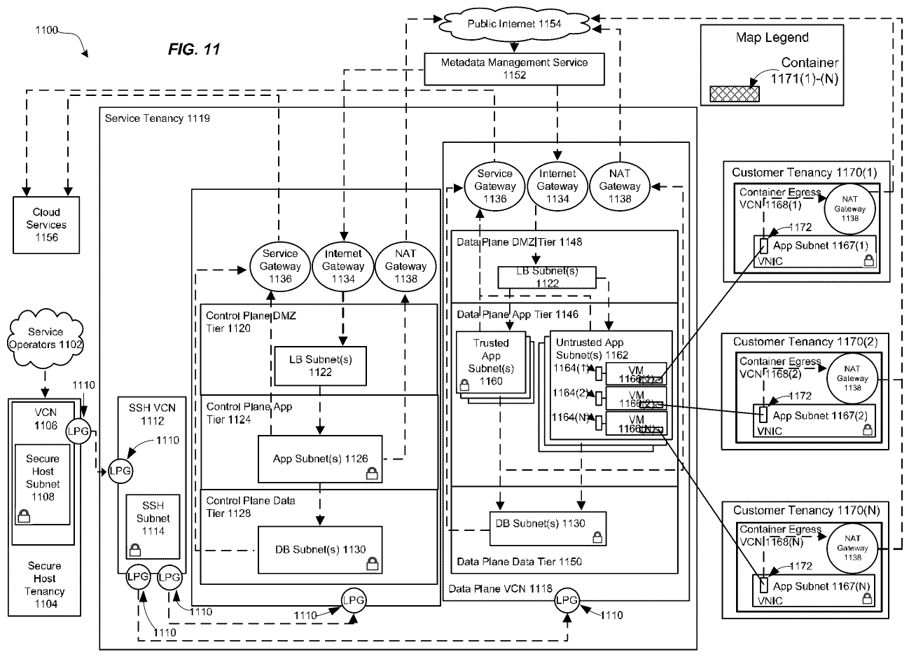

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a VCN 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

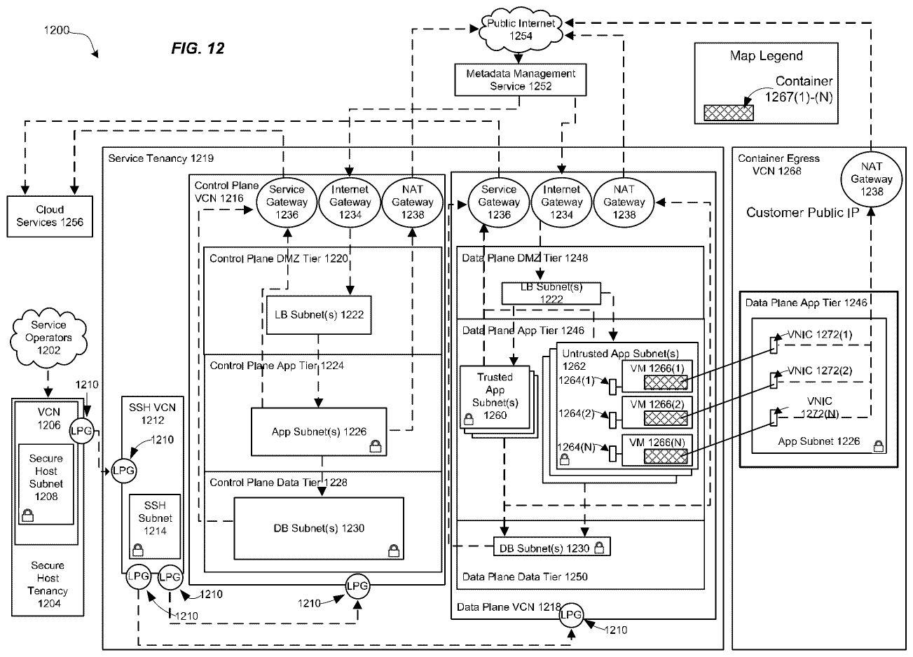

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a VCN 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1219 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 930 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively couple to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

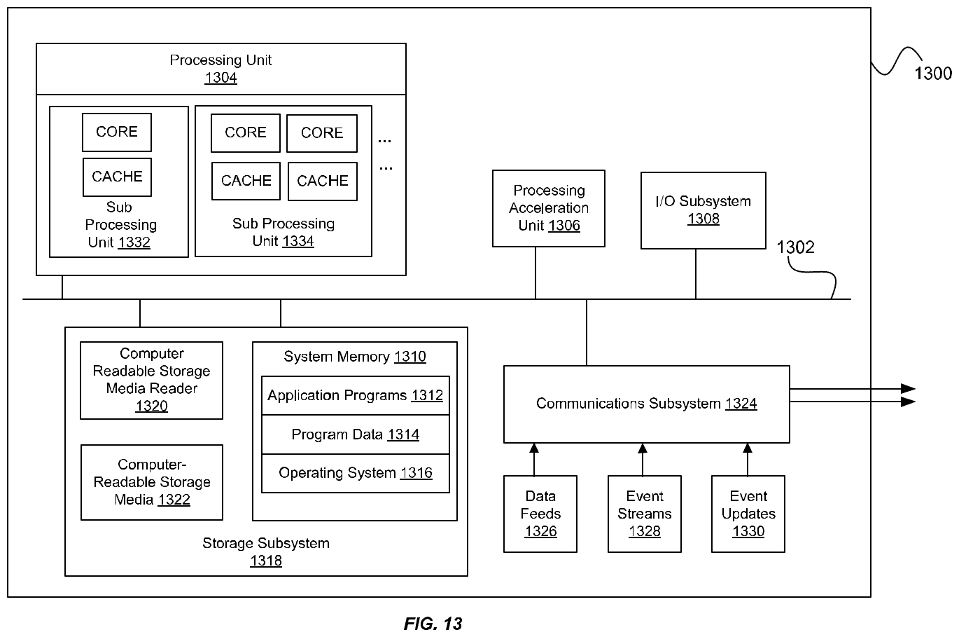

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may include a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. One or more computer-readable non-transitory storage media embodying software that is operable when executed to:
receive a first user request from a first user to implement a change in a security policy;
detect a dilution in security posture based on the implemented change in the security policy;
responsive to detecting the dilution in the security posture, request a first acknowledgement from the first user that the implemented change constitutes the dilution in the security posture;
record, in a database, the first acknowledgement from the first user that the implemented change constitutes the dilution in the security posture; and
determine, using the database, whether a security breach occurred within a time period when the dilution in the security posture existed.

2. The media of claim 1, wherein the first user is a first domain administrator of a domain within a tenancy managed by a cloud service provider, wherein the software is further operable when executed to:
responsive to detecting the dilution in the security posture, send notifications indicating the dilution in the security posture to a set of one or more users comprising a second domain administrator of the domain, a tenancy administrator of the tenancy, a security operator associated with the cloud service provider, or a security operator associated with the domain.

3. The media of claim 1, wherein the first user is associated with a tenancy managed by a cloud service provider, wherein the software is further operable when executed to:
determine a tenancy type associated with the tenancy;
determine a monitoring level for monitoring the tenancy based on the tenancy type and the dilution in the security posture; and
monitor the tenancy at the determined monitoring level.

4. The media of claim 1, wherein the software is further operable when executed to:
receive a second user request from a second user to restore the security policy to a default setting;
request a second acknowledgement from the second user that the restoration constitutes reverting back the implemented change in the security posture; and
record, in the database, the second acknowledgement from the second user that the restoration constitutes reverting back the implemented change in the security posture.

5. The media of claim 4, wherein the first user and the second user are a same user or different users.

6. The media of claim 4, wherein the software is further operable when executed to:
send notifications indicating the restoration of the security posture to the first and second users.

7. The media of claim 1, wherein requesting the first acknowledgement from the first user that the implemented change constitutes the dilution in the security posture is responsive to determining the first acknowledgement that the implemented change constitutes the dilution in the security posture does not exist in the database.

8. The media of claim 1, wherein the software is further operable when executed to:
determine a risk score corresponding to the dilution in the security posture based on the implemented change in the security policy.

9. The media of claim 8, wherein the first user is associated with a tenancy managed by a cloud service provider, wherein the software is further operable when executed to:
determine a monitoring level for monitoring the tenancy based on the risk score; and
monitor the tenancy at the determined monitoring level.

10. The media of claim 8, wherein the risk score is determined based on the security policy.

11. The media of claim 1, wherein the first user is associated with a domain, wherein the software is further operable when executed to:
receive a credit request associated with a security breach in the domain; and
reject the credit request responsive to determining that the security breach occurred within the time period when the dilution in the security posture existed.

12. The media of claim 1, wherein the first user is associated with a domain, and wherein the first user or a second user associated with the domain cannot modify or delete the recorded first acknowledgement in the database.

13. The media of claim 1, wherein the security policy is configured for accessing resources provisioned by a cloud service provider.

14. The media of claim 1, wherein the software is further operable when executed to:
in response to receiving the first user request, implement the change in the security policy.

15. One or more computer-readable non-transitory storage media embodying software that is operable when executed to:
receive a first user request from a first user to implement a change in a security policy;
detect a dilution in security posture based on the implemented change in the security policy; and
responsive to detecting the dilution in the security posture, increase a monitoring level for monitoring a tenancy associated with the first user.

16. The media of claim 15, wherein the first user is associated with a domain managed by a cloud service provider, wherein increasing the monitoring level comprises disabling an ability of the first user or a second user associated with the domain to change a limit of resources that the second user is eligible for consuming, and wherein the resources are provisioned by the cloud service provider.

17. The media of claim 15, wherein the first user is associated with a domain managed by a cloud service provider, wherein increasing the monitoring level comprises prohibiting a change in consumption of resources by the first user or a second user associated with the domain from exceeding a threshold value, and wherein the resources are provisioned by the cloud service provider.

18. The media of claim 15, wherein the first user is associated with a domain managed by a cloud service provider, wherein increasing the monitoring level comprises generating an alert upon determining consumption of resources by the first user or a second user associated with the domain exceeds a threshold value, and wherein the resources are provisioned by the cloud service provider.

19. The media of claim 15, wherein the software is further operable when executed to:
receive a second user request from a second user to restore the security policy to a default setting; and
decrease the monitoring level for monitoring the tenancy.

20. A system comprising: one or more processors; and a non-transitory memory coupled to the processors comprising instructions, when executed using the one or more processors, cause the one or more processors to execute:
receiving a first user request from a first user to implement a change in a security policy;
detecting a dilution in security posture based on the implemented change in the security policy;
responsive to detecting the dilution in the security posture, requesting a first acknowledgement from the first user that the implemented change constitutes the dilution in the security posture;
recording, in a database, the first acknowledgement from the first user that the implemented change constitutes the dilution in the security posture; and
determining, using the database to determine whether a security breach occurred within a time period when the dilution in the security posture existed.
